(19) United States
(12) Patent Application Publication
(10) Pub. No.: US 2024/0144446 A1
(43) Pub. Date: May 2, 2024

(54) SYSTEM AND METHOD FOR GAUSSIAN PROCESS AND DEEP LEARNING ATMOSPHERIC CORRECTION

(71) Applicant: UNIVERSITY OF VIRGINIA PATENT FOUNDATION, Charlottesville, VA (US)

(72) Inventors: William BASENER, Charlottesville, VA (US); Abigail BASENER, Charlottesville, VA (US)

(73) Assignee: UNIVERSITY OF VIRGINIA PATENT FOUNDATION, Charlottesville, VA (US)

(21) Appl. No.: 18/495,324

(22) Filed: Oct. 26, 2023

Related U.S. Application Data
(60) Provisional application No. 63/419,467, filed on Oct. 26, 2022.

(51) Int. Cl. G06T 5/00; G06T 3/40

(52) U.S. Cl. CPC G06T 5/002; G06T 3/4046; G06T 2207/10032; G06T 2207/20081; G06T 2207/20084

(57) ABSTRACT

Embodiments can relate to a system for producing a digital image by automatically correcting for scattering and/or absorption effects in an original digital image. The system can include a processor. The system can include memory containing a computer program that when executed will cause the processor to receive radiance spectra of a digital image, and execute a Gaussian machine learning model. The system can generate a reflectance parameter by predicting a ground reflectance value based on a Gaussian probability distribution of radiance spectra. The system can solve for a conversion coefficient based on the reflectance parameter. The system can produce an altered digital image by at least one or more of removing, filtering, and/or altering data for at least one pixel of a digital image based on the conversion coefficient.

### CROSS-REFERENCE TO RELATED APPLICATIONS

This patent application is related to and claims the benefit of priority to U.S. provisional patent application No. 63/419,467, filed on Oct. 26, 2022, the entire contents of which is incorporated by reference.

### FIELD

Embodiments relate to systems and methods for producing a digital image by automatically correcting for scattering and/or absorption effects in an original digital image.

### BACKGROUND INFORMATION

Atmospheric correction is the process of removing the scattering and absorption effects of the atmosphere on the reflectance values of images taken by satellite or airborne sensors. Known systems are inefficient and cannot provide accurate results, especially in situations in which there is no ground reflectance values that can be used in the correction process.

### SUMMARY

An exemplary embodiment can relate to a system for producing a digital image by automatically correcting for scattering and/or absorption effects in an original digital image. The system can include a processor. The system can include memory containing a computer program that when executed can cause the processor to perform any of the functions/operations disclosed herein. The computer program can cause the processor to receive radiance spectra of a digital image. The computer program can cause the processor to execute a Gaussian machine learning model. The computer program can cause the processor to execute the Gaussian machine learning model to generate a reflectance parameter by predicting a ground reflectance value based on a Gaussian probability distribution of radiance spectra. The computer program can cause the processor to execute the Gaussian machine learning model to solve for a conversion coefficient based on the reflectance parameter. The computer program can cause the processor to execute the Gaussian machine learning model to produce an altered digital image by at least one or more of removing, filtering, and/or altering data for at least one pixel of a digital image based on the conversion coefficient.

An exemplary embodiment can relate to a computer implemented method for producing a digital image by automatically correcting for scattering and/or absorption effects in an original digital image. The method can involve receiving radiance spectra of a digital image. The method can involve generating a reflectance parameter by predicting a ground reflectance value based on a Gaussian probability distribution of radiance spectra. The method can involve solving for a conversion coefficient based on the reflectance parameter. The method can involve producing an altered digital image by at least one or more of removing, filtering, and/or altering data for at least one pixel of a digital image based on the conversion coefficient.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1A shows an exemplary system configuration for an embodiment of the system, and

FIG. 1B shows components of an atmospheric radiative transfer model using the MODTRAN online;

FIG. 2 shows two plots of transmittance for two different atmospheric models created using the MOD-TRAN online interface;

FIG. 3 shows at-sensor radiance for 39 spectra and the mean plotted in black (left-hand plots) along with the true reflectance for these materials and the mean of their reflectance in black (right-hand plots), wherein the top row of plots have an atmosphere with greater absorption and the lower pair has less absorption;

FIG. 4 shows mean reflectance spectrum for 10 different groupings of 39 endmembers (left) and the reflectance and radiance values in two different bands for the mean from 15,000 of the observations;

FIG. 5 shows conditional probability density function for a multivariate normal distribution is a lower dimensional multivariate normal distribution;

FIG. 6: (left) shows two different mean radiance spectra for different endmember groups and different atmospheres, (right) shows the true mean reflectance for each endmember set, the GPAC predicted mean reflectance, and the QUACC-style universal mean, wherein it is observed that the GPAC predicted mean appears to be a better approximation to the actual mean;

FIG. 7 shows covariance matrices computed from the radiance and reflectance data for the parameters for the conditional probability;

FIG. 8 shows transmittance for various atmospheres plotted along with the first eigenvector (top) and the next three eigenvectors (bottom) for the matrix Σ̅;

FIG. 9 shows n exemplary autoencoder neural network used for converting from radiance to reflectance;

FIG. 10 shows training data for the auto encoder as an array of the radiance endmembers (upper-left) and array of the reflectance endmembers (lower-left); and

FIG. 11 shows that the true and predicted reflectance spectra for six endmembers for two different observation endmember sets and atmospheres, wherein 1/SNR for each band, with the SNR is the radiance value for the given band divided by the maximum radiance, is also shown.

### DETAILED DESCRIPTION

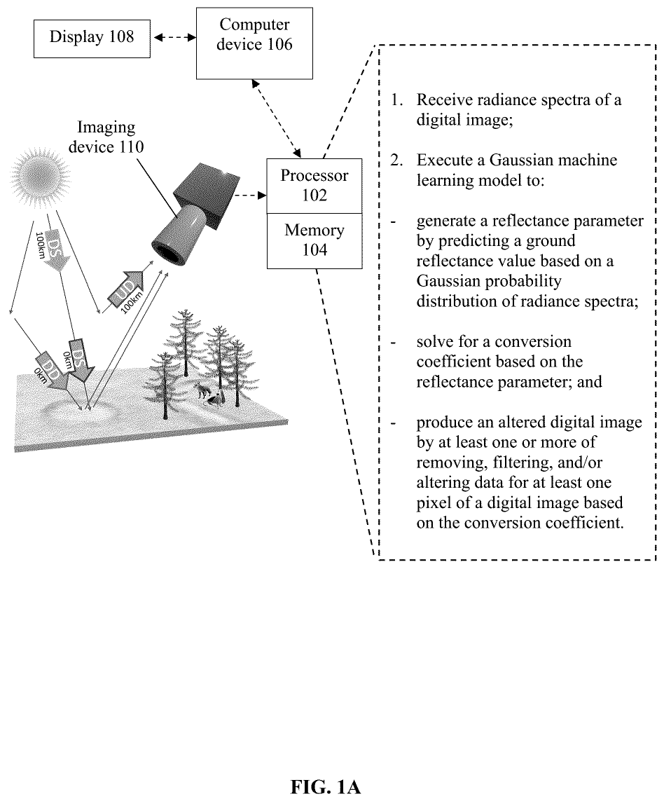

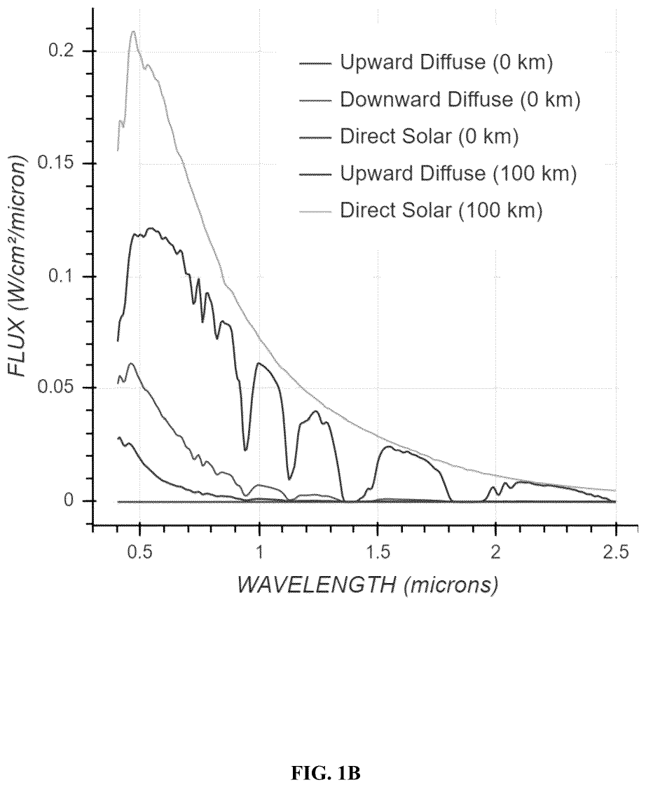

Referring to FIGS. 1A and 1B, an exemplary embodiment can relate to a system 100 for producing a digital image by automatically correcting for scattering and/or absorption effects in an original digital image. The system 100 can include a processor 102 (e.g., one or more processors 102). The system 100 can include memory 104 (e.g., one or more memories 104). Any number of the memories 104 can be associated with any number of processors 102. Being “associated with” as used in this disclosure can include two or more components being in operative association with each other so as to communicate with each other (which can be via hardwire or wireless communication). The system 100 can include memory 104 containing a computer program that when executed can cause the processor 102 to perform any of the functions/operations disclosed herein.

Any of the processors disclosed herein can be part of or in communication with a machine (e.g., a computer device, a logic device, a circuit, an operating module (hardware, software, and/or firmware), etc.). The processor can be hardware (e.g., processor, integrated circuit, central processing unit, microprocessor, core processor, computer device, etc.), firmware, software, etc. configured to perform operations by execution of instructions embodied in computer program code, algorithms, program logic, control, logic, data processing program logic, artificial intelligence programming, machine learning programming, artificial neural network programming, automated reasoning programming, etc. The processor can receive, process, and/or store data.

Any of the processors disclosed herein can be a scalable processor, a parallelizable processor, a multi-thread processing processor, etc. The processor can be a computer in which the processing power is selected as a function of anticipated network traffic (e.g., data flow). The processor can include an integrated circuit or other electronic device (or collection of devices) capable of performing an operation on at least one instruction, which can include a Reduced Instruction Set Core (RISC) processor, a Complex Instruction Set Computer (CISC) microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), distributed among two or more substrates, etc. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine-readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions or computer programs thereon. The instructions or computer programs can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Any of the processors can be in communication with other processors of other devices (e.g., a computer device, a computer system, a laptop computer, a desktop computer, etc.). For instance, the processor of the system 100 can be in communication with a processor of a computer device 106 or an imaging device 110, the processor of the computer device 106 can be in communication with a processor of a display 108, etc. Any of the processors can have transceivers or other communication devices/circuitry to facilitate transmission and reception of wireless signals. Any of the processors can include an Application Programming Interface (API) as a software intermediary that allows two or more applications to talk to each other. Use of an API can allow software of one processor to communicate with software of another processor of another device(s).

Any of the data or communication transmissions between two components can be a push operation and/or a pull operation. For instance, data transfer between the processor 102 and the memory 104 or the processor 104 and the imaging device 110, etc. can be push operation (e.g., the data can be pushed from the memory) and/or a pull operation (e.g., the processor can pull the data from the memory), data transfer between the system 100 and the computer device 106 can be a push and/or pull operation, etc.

When data is received by a component, it can be processed in real time, stored in memory for later processing, or some combination of both. After being processes by the component, the processed data can be used in real time, stored in memory for later use, or some combination of both. The pre-processed data and/or the processed data can be encoded, tagged, or labeled before, during, or after being stored in memory.

As noted herein, the system 100 can include memory 104 containing a computer program that when executed can cause the processor 102 to perform any of the functions/operations disclosed herein. The computer program can cause the processor 102 to receive radiance spectra of a digital image. For instance, the radiance spectra of the digital image can be extracted from the digital image, wherein the radiance spectra are received by the processor 102. The digital image can be image or video data generated by an imaging device 110 (e.g., a camera, a telescope, a satellite imaging apparatus, a RADAR apparatus, a LIDAR apparatus, a sensor, etc.). The digital image can be one or more digital image files, a portion of a digital image file, etc. In an exemplary embodiment, the digital image is one or more digital image files generated by a satellite imaging apparatus, wherein the system 100 produces an altered digital image by automatically correcting for scattering and/or absorption effects in the original digital image generated by the satellite imaging apparatus. As will be explained herein, the altered digital image can be generated by executing one or more machine learning models.

The computer program can cause the processor to execute one or more machine learning models (e.g., linear regression model, tree based model, perceptron based model, Gaussian based model, etc.). It is contemplated for at least one of the machine learning models to be a Gaussian machine learning model. The processor 102 can execute the machine learning model to generate one or more reflectance parameters by predicting one or more ground reflectance values based on a trained data set. For example, the processor 102 can use the machine learning model to generate one or more reflectance parameters by predicting one or more ground reflectance values based on a Gaussian probability distribution of radiance spectra. In other words, a reflectance parameter(s) is/are generated by predicting what the ground reflectance value(s) should be for the digital image. This prediction can be based on a Gaussian probability distribution of radiance spectra and a trained data set. Once the ground reflectance value(s) are accurately predicted, reflectance parameter(s) can be generated that are representative of this/these predictions. These reflectance parameter(s) can be used to solve for conversion coefficient(s) (e.g., the processor 102 can execute the machine learning model to solve for one or more conversion coefficients based on the reflectance parameter), which can then be used to convert or alter the digital image so as to correct for scattering and/or absorption effects.

The computer program can cause the processor 102 to execute the machine learning model to produce an altered digital image by at least one or more of removing, filtering, and/or altering data for at least one pixel of a digital image based on the conversion coefficient(s). For example, the conversion coefficient(s) can be used to generate or control one or more digital image processing techniques so as to cause the digital image data to correspond with (e.g., approximate to, match, etc.) the predicted ground reflectance value(s). The digital image processing technique(s) can include removal or addition of color, amplification or attenuation of signal strength, filtering techniques (e.g., Gabor filtering, spatial filtering, frequency filtering, etc.), etc. The determination of which pixel to perform the processing on, which type of processing, the degree with which the processing occurs, etc. can be set by design criteria, optimization factors, computational resources, processing speed, etc.

As can be appreciated from the present disclosure, the system 100 can use the machine learning model(s) to determine that radiance spectra from a digital image include information about gasses or other materials. For instance, the model can generate reflectance parameter(s) that are representative of predicted ground reflectance values of a certain type of gas or group of gasses or other material. The system 100 can then determine that this/these gas/gasses are present—e.g., the system 100 can be used as a sensor to detect presence of gasses or materials. As a non-limiting example, an imaging device 110 can be a device used by a satellite, aircraft, drone, etc. that captures digital image(s) of an area, wherein the system 100 can process the digital image(s) and determines if hazardous gasses or material is present in that area based on the reflectance parameters generated after processing the digital image(s). The system 100 can generate a signal (e.g., audio, visual, graphical, etc.) based on the reflectance parameters to inform or alert a user of the system 100 that the hazardous gasses or material is present. In addition, or in the alternative, the system 100 can generate a color-coded representation of the digital image(s) (e.g., a heat map) that shows which area captured by the digital image(s) contains the hazardous gasses or material—i.e., the reflectance parameters can be used as input to color code certain pixels so as to illustrate where the gasses or material is located in the digital image(s).

As can be appreciated from the disclosure, embodiments disclosed herein can improve operation of the processor 102. This can be achieved by implementing an algorithm that will improve efficiency of processor operation by requiring less iterations. For example, the algorithm can cause the processor 102 to quickly and accurately process a digital image in a more efficient manner (e.g., with less iterations). In addition, the processor 102 can efficiently and accurately identify scattering and/or absorption effects and correct for the same without having current ground reflectance values—i.e., known system require receiving ground reflectance values that were generated at the same time the radiance spectra were generated in order to accurately identify scattering and/or absorption effects. These improvements can yield higher precision, require less computational resources, require less processing steps, etc.

The computer program can cause the processor 102 to receive the radiance spectra of a digital image (e.g., the radiance spectra can already be extracted from the digital image), receive the digital image and extract radiance spectra therefrom, or a combination of both. The processor 102 can receive the radiance spectra and/or digital image from one or more imaging devices 110, for example. In some embodiments, the system 100 includes the processor 102 and memory 104, and in some embodiments the system 100 includes the processor 102, memory 104, and the imaging device 110.

It is contemplated for the computer program to cause the processor 102 to generate plural reflectance parameters and solve for plural conversion coefficients based on the plural reflectance parameters. With plural reflectance parameters, the computer program can cause the processor 102 to predict ground reflectance values by generating one or more approximate ground reflectance output vectors from one or more radiance spectra input vectors. This can be done in a Bayesian framework, for example. This can facilitate generating an altered digital image by at least one or more of removing, filtering, and/or altering data pertaining to a scattering and/or absorption effect on reflectance of a digital image. This can be done by generating offset values based on the approximate ground reflectance output vectors. Thus, the processor 102 can generate the altered digital image by generating an offset value(s) and applying the offset value(s) to at least one pixel of a digital image. It is contemplated for the processor 102 to generate the altered digital image by generating a single offset value and applying that single offset value to each pixel of a digital image.

In some embodiments, the computer program can cause the processor 102 to execute a denoising autoencoder machine learning model. The denoising autoencoder machine learning model can be used to encode digital image data by passing digital image data through plural layers of a deep learning neural network that decrease in size leading to a dimensionally smaller representation of the data. The denoising autoencoder machine learning model can be used to decode digital image data by passing encoded digital image data through a symmetric series of layers until the reaching a data shape (e.g., an original data shape) before being encoded. The denoising autoencoder machine learning model can be used to learn a representation of data in a reduced dimensional space to facilitate removal of noise during encoding and recovery of data in original space during decoding. The denoising autoencoder machine learning model can be used to process the digital image data before or after being processed by the Gaussian machine learning model.

An exemplary embodiment can relate to a computer implemented method for producing a digital image by automatically correcting for scattering and/or absorption effects in an original digital image. The method can involve receiving radiance spectra (which can be from an imaging device 110) of a digital image and/or receiving a digital image (which can be from an imaging device 110) and extracting radiance spectra therefrom. The method can involve generating a reflectance parameter(s) by predicting a ground reflectance value(s) based on a Gaussian probability distribution of radiance spectra. The method can involve solving for a conversion coefficient(s) based on the reflectance parameter(s). The method can involve producing an altered digital image(s) by at least one or more of removing, filtering, and/or altering data for at least one pixel of a digital image(s) based on the conversion coefficient(s).

In some embodiments, predicting a ground reflectance value(s) can include generating one or more approximate ground reflectance output vectors from one or more radiance spectra input vectors in a Bayesian framework. Generating the altered digital image(s) can include at least one or more of removing, filtering, and/or altering data pertaining to a scattering and/or absorption effect on reflectance of a digital image(s). Generating the altered digital image(s) can include generating at least one or more offset values and applying the at least one or more offset values to at least one pixel of a digital image. In some embodiments, the method can involve generating the altered digital image(s) can include generating a single offset value and applying that single offset value to each pixel of a digital image.

In some embodiments, the method can involve: encoding digital image data by passing digital image data through plural layers of a deep learning neural network that decrease in size leading to a dimensionally smaller representation of the data; decoding digital image data by passing encoded digital image data through a symmetric series of layers until the reaching a data shape before being encoded; and learning a representation of data in a reduced dimensional space to facilitate removal of noise during encoding and recovery of data in original space during decoding.

### EXAMPLES

The following describe exemplary methods and systems developed, along with test results for the exemplary methods and systems.

Atmospheric correction is the processes of converting radiance measured at a spectral sensor to the reflectance of the materials in a multispectral or hyperspectral image. This is an important step for detecting or identifying the materials present in the pixel spectra. Disclosed herein is two machine learning models for atmospheric correction trained, which were tested on 100,000 batches of 40 reflectance spectra converted to radiance using MODTRAN. This allowed the machine learning models to learn the radiative transfer physics from MODTRAN. A theoretically interpretable Bayesian Gaussian process model was also developed. A deep learning autoencoder was also developed for treating the atmosphere as noise. Both methods were compared for estimating gain in the correction model to the well-known QUAC method of assuming a constant mean endmember reflectance. Prediction of reflectance using the Gaussian process model outperforms the other methods in terms of both accuracy and reliability.

As noted herein, atmospheric correction of a hyperspectral or multispectral image is the process of converting the observed at-sensor radiance (e.g., the amount of light per wavelength measured at the sensor) to ground reflectance (e.g., the percent reflectance per wavelength of the material(s) located at on the ground). This research tests two methods for machine learning of atmospheric radiative transfer from collections of spectra from a hyperspectral image. Each method takes in a collection observed pixel spectra from a hyperspectral image and outputs the reflectance spectra for the pixels, providing coefficients for atmospheric correction that can be applied to the entire image.

A hyperspectral image is a digital image in which each pixel has more than the visual three color (red, green, blue) bands, but often hundreds of bands across wavelengths sufficient to get spectral information about the materials in each pixel. In this research, hyperspectral images that have band wavelengths from about 400 nm to 2500 nm are used—for comparison the visual colors occur around 450 (blue), 550 nm (green) and 650 nm (red)—and the spectra have 452 bands as collected with 375 bands after removing bands where the signal is absorbed by water vapor. For a hyperspectral image collected at these wavelengths, the measured light at the sensor is primarily reflected sunlight, having passed through the atmosphere, reflected off materials, and passed again through some amount of atmosphere (which may be small for a ground-based space or significant if the sensor is on board an aircraft or satellite). Each band is typically 2 nm to 10 nm wide, and the bands are contiguous across the wavelength range. The reflectance for a material is important because it is the result of the interaction of photons at different wavelengths and the resonant frequencies of molecular bonds (for the wavelengths above the visible range) and the interaction of photons and electrons moving between quantum states (for wavelengths around the visible range). Specifically, important information about the constituents and bonds present in a material can be computed from reflectance spectra, for example distinguishing between different polymers, or distinguishing talcum powder from powdered sugar from dangerous white powdered substances.

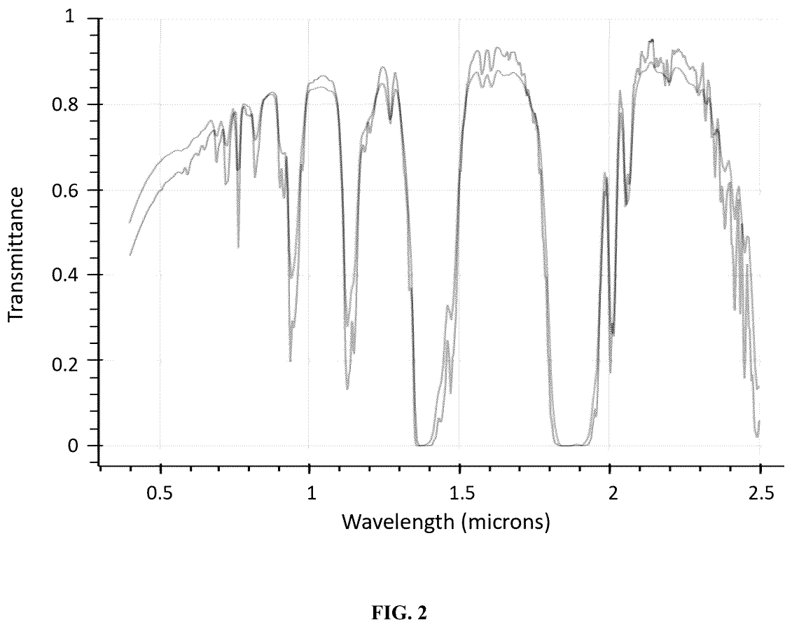

As light propagates through the atmosphere, some light is absorbed by the particles and gases in the atmosphere, some light is scattered, and some light passes through the atmosphere. Light at lower wavelengths has greater probability of being scattered (the blue sky effect), and generally the fraction of light that is absorbed varies with wavelength, depending on the gasses and particles present. The percentage of light that passes through the atmosphere is called transmittance, which is a function of wavelength for a given atmosphere. This transmittance can be computed from physical measures for a given atmosphere (density of water vapor, sun and sensor angles, etc.) using MODTRAN (MODerate resolution atmospheric TRANsmission) software. A plot of transmittance for two different atmospheric models created using the MODTRAN online interface across our wavelength range with a spectral resolution (band width) of 5 nm is shown in FIG. 2. Observe that these two spectra differ in magnitude and in depth of the absorption features that occur at various wavelengths. Our main goal includes determining this transmittance fraction from spectra on the ground measured from a sensor even when the reflectance of the ground material is unknown.

The plot in FIG. 1B shows more components involved in the radiative transfer model, also generated with the MODTRAN online interface. The Direct Solar (100 km) gives the amount of sunlight measured at the top of the atmosphere. The main shape of this curve is from the blackbody radiation given the temperature of the sun. The Direct Solar (0 km) is the amount of sunlight reaching the ground, which is the Direct Solar (100 km) times a transmittance similar to that shown in FIG. 2. The Downward Diffuse (0 km) is the amount of light per wavelength that reaches the ground after scattering in the atmosphere; this is the indirect illumination on an object, for example on an object in a shadow from the sun. The upward Diffuse is the amount of upward light, which at 100 km (top of atmosphere) is from atmospheric scattering and at 0 km is from the blackbody radiation of the ground (which is insignificant given the wavelength range and ground temperature assumed in this model).

The at-sensor radiance is the Upward Diffuse (at the elevation of the sensor) plus the total illumination at the ground (Direct Solar+Downward Diffuse) times the percent reflectance per band of the material on the ground per wavelength Re f_{λ},

UD_{λ}+(DS_{λ}+DD_{λ})Ref_{λ}=Rad_{λ}.

There are additional nonlinear effects as well. Light that has passed through a leaf and reflected off the ground would have the leaf transmittance times ground reflectance in place of Re f_{λ} in this equation. In the lower wavelengths, especially blue and below, photons will take multiple bounces/scattering (collectively, ‘haze’ in the image) in the atmosphere. This multiple bounce haze causes additional upward diffuse and additional downward diffuse illumination on the ground. There are also photons that reflect off material at one ground location and then scatter in the atmosphere to enter the sensor at locations/directions for other pixels, causing an “Upward Diffuse” that varies across the image comprised of a nonlinear mixture of nearby ground material spectra and atmospherics, rather than the ideal Upward Diffuse from the atmosphere alone. These nonlinear effects are minimal in most cases.

All of these values change with respect to atmospheric constituents, water vapor, CO2, Ozone, CH₄, aerosols, sun angle, fraction of sun and sky visible to each pixel (shadow from objects, terrain, clouds, etc.), sensor angle, angle and roughness of the ground material, and other factors. The MODTRAN software can simulate these effects if they are known, and provide a modeled at-sensor radiance for reflectance spectra, or an approximated ground reflectance spectrum for a measured at sensor radiance.

The purpose of hyperspectral imaging is to perform spectroscopy writ large; that is, to be able to determine the materials in each pixel from the reflectance spectra for those pixels. As such, good atmospheric compensation is an essential step. The most accurate methods either use physics-based modelling with MODTRAN such as FLAASH or using materials of known reflectance in the image, for example the empirical line method, in which case it is usually preferable to have materials that are spectrally flat, for example a set of five panels which are 5%, 30% 50% 80% and 95% reflectance across all wavelengths, which can be used to estimate a best fit regression line per wavelength to convert from radiance units to reflectance. However, both of these methods make approximations in their modelling of physical parameters. For example, a good ELM will estimate the upward diffuse as the intercept and the direct solar and downward diffuse as the slope, but assume these are consistent values for every pixel in the image. FLAASH attempts to estimate the physical parameters from the image radiance spectra based on user input of parameters, even estimating water vapor content per pixel, and use a physics based model to compute the grouped reflectance from each at-sensor radiance measurement.

A heuristic and approximate but surprisingly effective method for atmospheric correction is to make the assumption that the mean spectrum of a significantly large diverse library of reflectance spectra will be constant (independent of the spectra used and varying only with wavelength, called the ideal mean reflectance), and use this assumption to compute a single gain and offset that is applied per wavelength across the image. A method based on this assumption is QUACC (QUick Atmospheric Correction Code), which functions approximately as follows. First, the minimum measured radiance value across the image per wavelength is assumed to be the upwelling radiance at the sensor (offset), and is thus subtracted from the image. The top of atmosphere solar radiance (Direct Solar in FIG. 1B) is approximated using a plank function at the observed temperature of the sun, and this value is divided by the radiance values per band as a first step in correcting for illumination intensity. Then a sample of 50 different spectra (called endmembers) are selected from the radiance image, usually iteratively so each new endmember is optimally different than the previous ones, and the mean of these 50 endmembers is determined. Then the ratio between the ideal mean and mean of the endmembers is computed and used as a ‘gain’ and is multiplied by every upwelling-subtracted radiance value to convert to reflectance. This is often implemented with additional heuristic improvements such as removing spectra of mud or vegetation from the spectra, and is provided in QUACC. There are other semi-heuristic methods for example SHARC.

The QUAAC method is faster than physics-based methods and unlike FLAASH requires no manual input. In tests, it often provides reflectance spectra that are generally ±15% in comparison to FLAASH generated reflectance spectra, and perhaps more importantly QUACC tends to generate reflectance spectra that retain the features of the true spectra, which is the most important factor for spectroscopy. The main assumptions in QUACC are:
Q1 Assuming that the atmospheric correction is linear, comprised of an offset (upward diffuse) and gain (transmittance per band).
Q2 Assuming the minimum radiance value observed in each band is the upward diffuse.
Q3 Assuming that the mean reflectance of a collection of spectral diverse spectra is always the universal mean.

The inventive method provides for a Gaussian process atmospheric correction process that does not make assumption 3, and a denoising autoencoder atmospheric correction process that can be used avoiding all 3 assumptions.

Materials and Methods

Two machine learning models were developed and tested to transform the radiance data to reflectance. The first method, which showed exceptional performance, is a Gaussian process model. The second method is a deep learning model using a denoising autoencoder, training the autoencoder as if the atmospheric effects are noise. These methods were trained and tested on reflectance spectra with associated radiance that were computed using MODTRAN.

Data

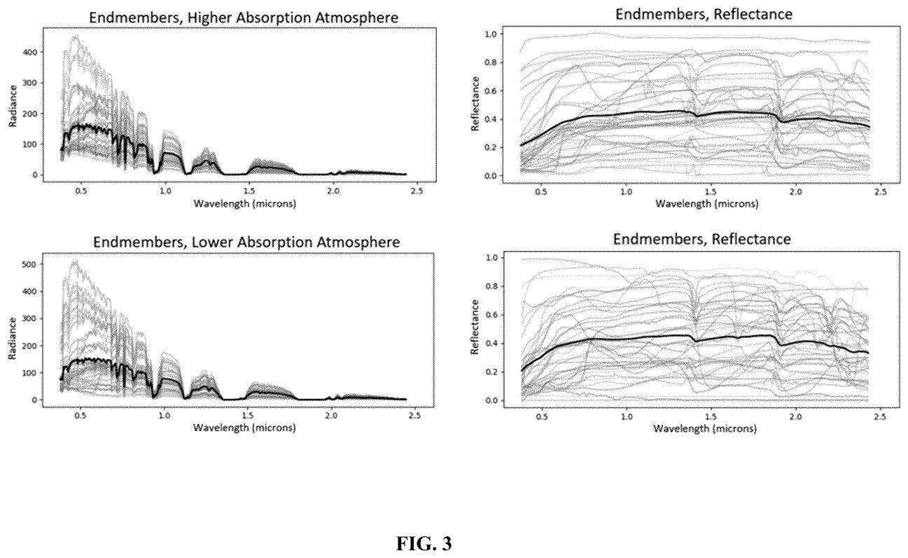

For this research, a set of about 1,200 reflectance spectra of known materials was used initially, each of which passed some basic quality checks. These spectra have 452 bands contiguous ranging from 400 nm to 2400 nm, resulting in 375 bands after removing bands in the 1340-1440-nm and 1800-2000 nm ranges because light in these wavelengths is completely or nearly completely absorbed by water in the atmosphere. Random samples of size 39 were randomly selected a set of parameters for MODTRAN (solar zenith angle from 0-85 in increments of 5, random selection from the 6 possible atmospheric models, random selection from the 12 possible aerosol models) and created an associated set of 39 at-sensor radiance spectra. For each set, the mean spectrum was computed and added this as a 40th spectrum. So the input data is a set of 40 radiance spectra each with 375 wavelengths, and the output data is a set of 40 reflectance spectra. The software maintained the option to include the upwelling (offset) term, to exclude it (approximating a situation where it was estimated in-scene for example by a darkest pixel per band method). FIG. 3 shows plots of the 40 radiance spectra (left) and the associated reflectance spectra (right). 100,000 of such groupings of 40 reflectance spectra were created, wherein the randomly selected atmospheric model was applied to generate the associated radiance. The goal is to train a machine learning model to take the radiance spectra as an input and output the reflectance spectra. Two-thirds of our data was randomly selected for training and the remaining sets of spectra used for testing.

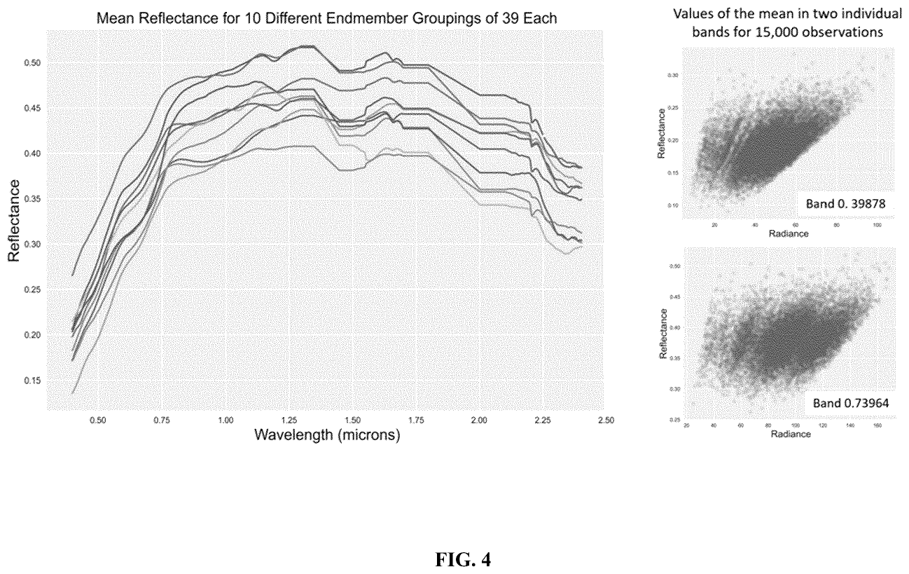

FIG. 4 shows reflectance and radiance values from different endmember means, showing that there is significant variation in both the radiance and reflectance values for different groupings of endmembers and atmospheres. These plots indicate the error in QUACC assumption Q3, that the mean of a group of reflectance spectra is constant.

Gaussian Process Atmospheric Compensation

The Gaussian process model can be described using conditional probabilities as follows. Let x=(Rad_{λ}_{₁}, Rad_{λ}_{_{N}}) denote the N-dimensional vector of values for the mean for a set of radiance endmembers, and let y=(Ref_{λ}_{₁}, . . . , Ref_{λ}_{_{N}}) be the N-dimensional mean vector of the reflectance for these endmembers. Let z be the 2N-dimensional concatenation of x and y,

z=(Rad_{λ}_{₁}, . . . , Rad_{λ}_{_{N}}, Ref_{λ}_{₁}, . . . , Ref_{λ}_{_{N}}).

Capital letters X, Y, and Z are used for the arrays consisting of k observations of each type, which are of size k×N, k×N, and k×2N respectively.

Making the assumption that Z is a multivariate normal random variable, one can compute the mean μz and covariance Σ_{z}. Let μₓ and μ_{y} be the means for the radiance and reflectance so that μ_{z} is the concatenation of μₓ and μ_{y}. If one denotes the covariance of the Z by Σ_{z}, the covariance of X by Σₓₓ, and the covariance of Y by Σ_{yy}, then the covariance matrix Z can be written in block form as

$$[ \begin{matrix}{\sum }_{x x} & {\sum }_{x y} \\ {\sum }_{y x} & {\sum }_{y y}\end{matrix} ] .$$

Then for a given radiance x₀ which is the mean of endmembers, one can get the conditional probability distribution for the reflectance as the multivariate normal distribution:

P(y|x=x₀)=Nμ̅;Σ̅)

where

μ̅=μ_{y}+Σ_{yx}Σₓₓ⁻¹(xₒ−μₓ) (1)

Σ̅=Σₓₓ−Σ_{yx}Σₓₓ⁻¹Σ_{xy}. (2)

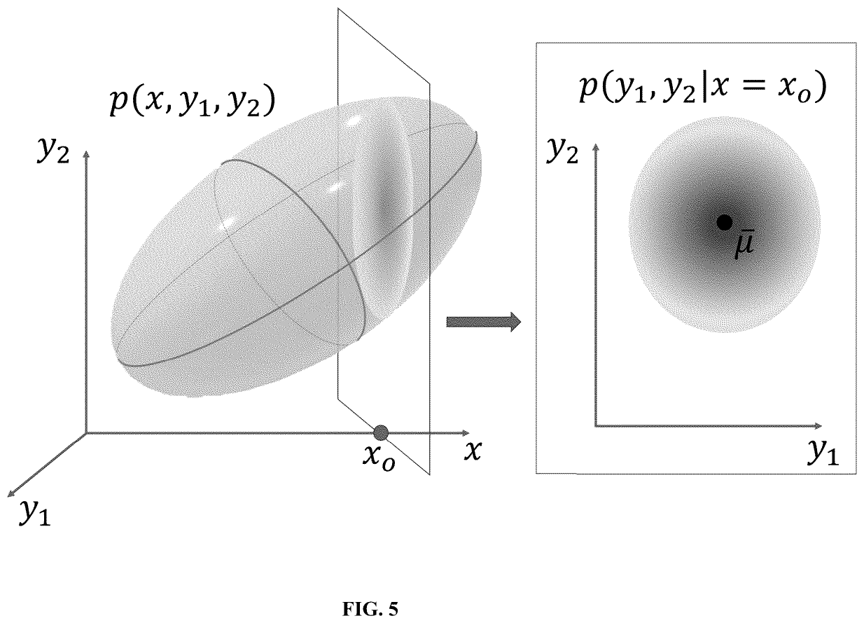

This conditional probability density function is depicted in the case where x is one dimensional and y is two dimensional in FIG. 5. The predicted mean reflectance is then the expected value of the reflectance given the observed radiance,

E[y|x=xₒ]=\hat{μ}

FIG. 5 show conditional probability density function for a multivariate normal distribution is a lower dimensional multivariate normal distribution. The description of a Gaussian processes model was in the context of predicting reflectance from radiance, but this GP is a machine learning method that in general predicts an output vector from an input vector in a Bayesian framework assuming the Gaussian probability distributions. It is often used for predicting financial or cyclical weather patterns from data, where the input is the value of some measurement over time, and the output is the values over a following set of times. More generally it can be applied to any function of a continuous parameter (e.g., time or in this case wavelength) where the measured output value at any finite set of input parameter values is a multivariate Gaussian random variable. This includes the case of continuous input variables (infinite dimensions) but the computation is done on a discrete input parameters subset for obvious computational reasons.

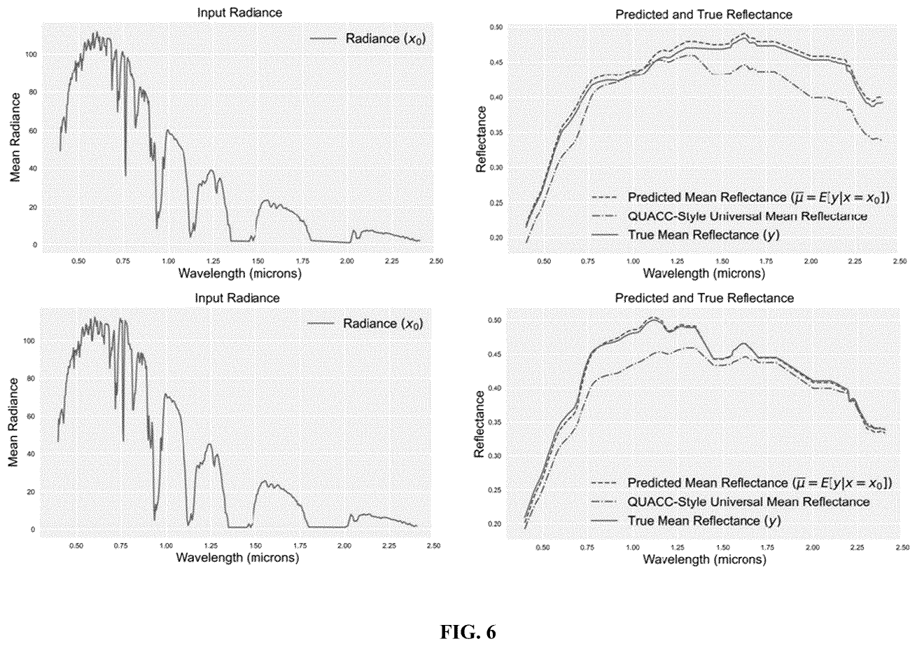

This predicted mean reflectance can be used in atmospheric correction similar to how the ‘universal mean’ is used in QUACC, as follows. First, for each band the minimum value over all pixels in the image for that band is determined, and this minimum value is used as the offset, which is an estimate for the upwelling radiance. This offset is subtracted from every pixel in the image, and then a collection of endmembers is collected from the image. The mean of these endmembers is the radiance vector x₀, and the predicted reflectance is μ̅. The gain for the atmospheric conversion is μ̅/y, which is multiplied per-band by every spectrum in the image to complete conversion to reflectance. Two examples of mean of the radiance endmembers (left) and predicted reflectance (right) are shown in FIG. 6 using observations from our test data. Observe that the method accurately predicts the mean reflectance spectra even though these means differ from each other significantly. This allows for accurate atmospheric correction in situations where the assumption in QUACC of a universal mean is not a reasonable assumption.

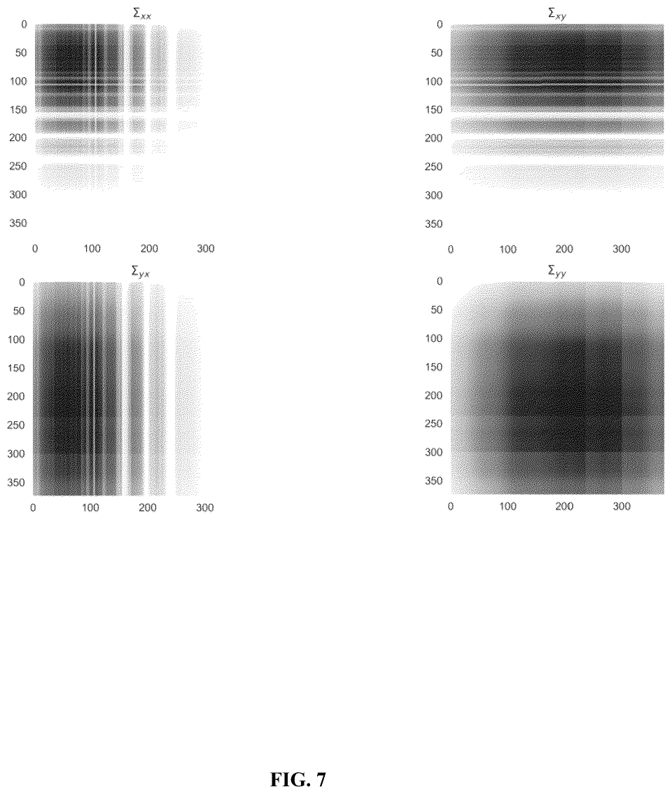

The covariance matrices computed from the radiance and reflectance training data for the parameters computations in 1 are shown in FIG. 7. From this figure it can be seen that Σₓₓ is a covariance matrix for reflectance spectra, Σ_{yy} is a covariance for radiance spectra, and the off diagonal matrices indicate a conversion between units.

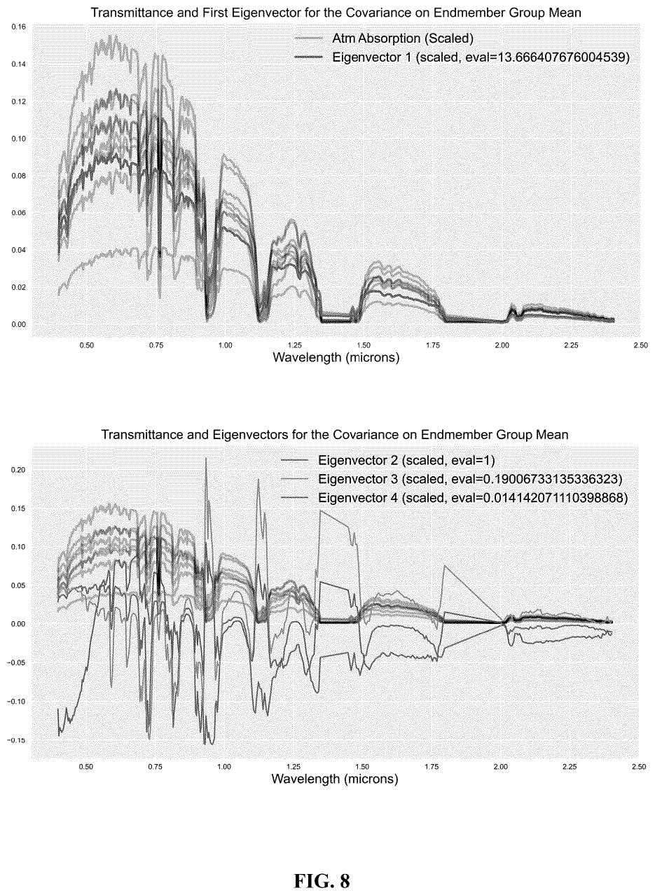

An advantage of the conditional probability in the Gaussian process is that we can unpack the model to determine what it is learning. This method is not a black box. In FIG. 8, the first four eigenvectors of the covariance matrix Σ̅ along with transmittance spectra are plotted. These eigenvectors show that the conditional probability is learning variation in the transmittance for atmospheres of varying physical properties.

Denoising Autoencoder Atmospheric Compensation

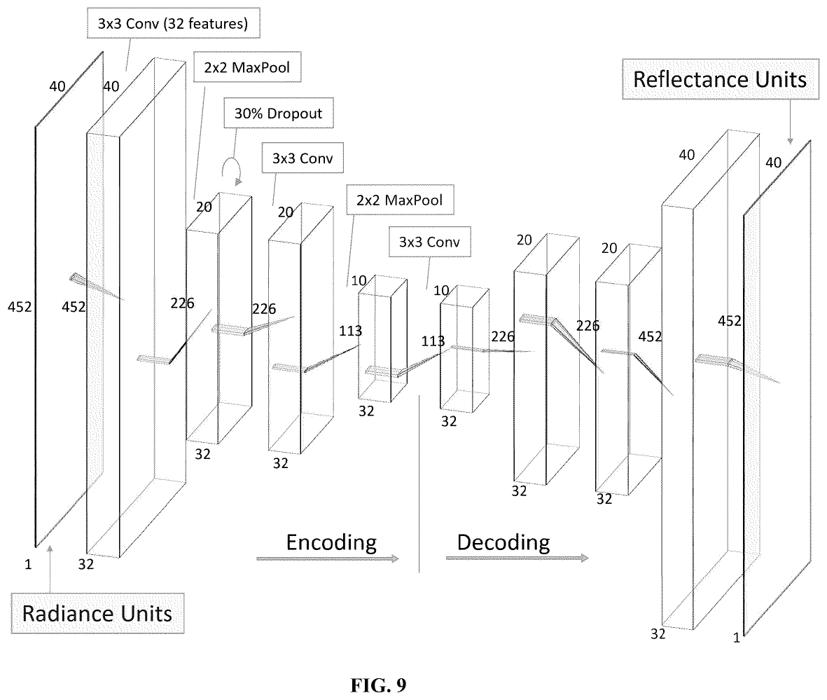

An autoencoder is a deep learning neural network that passes data through a series of layers that decrease in size leading to a dimensionally smaller representation of the data (encoding), and then passing the data through a symmetric series of layers back to the original data shape (decoding). When trained well, the process learns a representation of the data in the reduced dimensional space so that the encoding stage removes noise and the decoding stage recovers the data in the original space. A diagram of the architecture of our autoencoder is shown in FIG. 9.

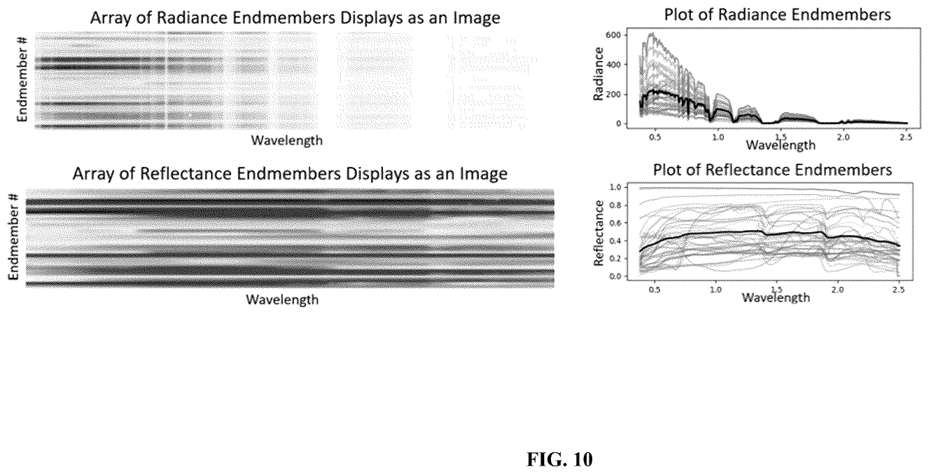

The autoencoder is trained on the reflectance and radiance data described previously (removing the last 3 bands to provide an appropriate even number for the autoencoder), providing the full 40×372 2-D array of endmembers and mean for each rather than just the mean. One training data observation with both radiance (input for the autoencoder) and reflectance (output) is shown in FIG. 10. All of our data and methods are provided open access.

Results

All three methods were tested: Gaussian process (GPAC), universal mean regression (UMR), and the denoising autoencoder (DA) for atmospheric correction on out test data. The data consisted of 100,000 observations, where each observation has an X input array of 40 radiance spectra and a Y output variable of these 40 spectra in reflectance. The radiance was created from the reflectance by apply a MODTRAN atmospheric absorption. For each observation, the reflectance spectra were a random selection from a library of over 1000 spectra and the parameters for the MODTRAN atmosphere were randomly selected. The data was randomly split into 66,667 training observations and 33,333 test observations. The test set is then 33, 333×39=1,299,987 unique radiance-reflectance pairs of spectra (The mean for scoring was excluded, so each group has 39 rather than 40).

Each method was applied to the each test observation to determine a predicted reflectance spectrum for each radiance. (The GPAC and UMR methods each produce a mean reflectance which is used to determine a gain, which is then applied to each radiance spectrum to obtain the reflectance, while the DA directly provides a predicted reflectance for each radiance spectrum.) The following metrics were then computed.
Mean correlation: The mean of the correlations between each predicted reflectance spectrum with the corresponding true reflectance
Standard Deviation in Correlation: The standard deviation of the correlations between each predicted reflectance spectrum with the corresponding true reflectance.
Percent with all bands in ±15% of True: The percent of spectra (out of the 1,299,987) for which the predicted reflectance is within ±15% of the true reflectance for all bands.
Percent with >98% of bands in ±15% of True: The percent of spectra (out of the 1,299,987) for which the predicted reflectance is within ±15% of the true reflectance for at least 98% of the bands.

The mean correlation between the predicted and true spectra is an important metric because most material detection and identification process incorporate correlation (in native or PCA space), and moreover the chemical bonds in materials appear as features (minima, maxima, slopes, etc.) in the spectra, and correlation between spectra captures these better than absolute difference. It is clear from our test that the GPAC method provides the most accurate (highest mean) and most consistent (lowest standard deviation) results when measured in by correlation between predicted reflectance and true reflectance.

The two metrics measuring how well the predicted reflectance stays within plus or minus 15% of the true reflectance provide additional import information on accuracy. This type of comparison has been used to justify the accuracy of QUACC. Often, the predicted reflectance will be close to the true reflectance except for a small number of bands near the water band regions, where high absorption from a particular atmosphere can result in low signal in the radiance spectra and unnaturally high values in predicted reflectance for GPAC and UMR. The GPAC method performed the best by these metrics as well. Notably, for 73% of spectra the predicted reflectance with was within 15% of the true reflectance for at least 98% of the bands, while this was true for UMR for only 41% of the spectra.

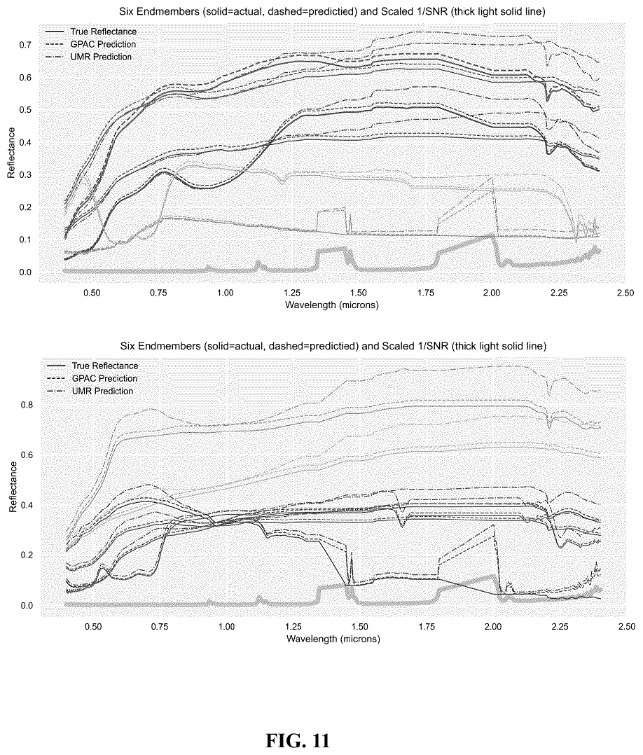

Six reflectance endmembers along with their approximated reflectance from GPAC are shown for two different observations sets in FIG. 11. Observe that along the edges of the water band regions, that 1/SNR (where SNR for a bands λ is the max radiance over all bands divided by the radiance value for band λ) is higher and there are poor approximations for the individual bands. This is a problem that arises in all atmospheric correction methods where the low SNR water bands result in poor reflectance estimates.

More importantly, atmospheric correction using the GPAC predicted spectra is more accurate than using the QUACC-style universal mean regression prediction. For example, in the upper plot observe that the UMR reflectance are close approximations up to about 1.2 microns, then there are unrealistic features in the 1.2 to 1.5 micron range, and then a growing over-approximation of the reflectance from 1.75 on. in the lower plot, the universal mean regression prediction has an unrealistic feature created around 0.55-0.9 microns, and as previously an over-approximation of the reflectance from 1.25 microns on, which seems to increase with increasing wavelength. These observations are all consistent with the results of Table 1.

TABLE 1
Evaluation metrics for the Gaussian process prediction, universal
mean regression, and denoising autoencoder methods.

| Metric | GPAC | UMR | DA |
|---|---|---|---|
| Mean Correlation | 0.96 | 0.94 | 0.86 |
| Std. Deviation in Correlation | 0.11 | 0.14 | 0.19 |
| percent with all bands in ±15% of True | 43% | 23% | 0.3% |
| percent with >98% of bands in ±15% of True | 73% | 41% | 1.4% |

### CONCLUSIONS

The most common automated atmospheric compensation method is QUACC. In this method, after estimating and removing an offset (upwelling diffuse), a set of endmembers is selected and the UMR method is used to estimate a gain (transmittance), which is then applied to the whole image. Some additional heuristics are used, such as excluding vegetation or mud from the endmembers and choosing a subset of bands for endmember selection. Despite the approximations, this method generates reasonable reflectance spectra that are with 15% of those generated with physics-based methods such as FLASH.

The theoretical design of the Gaussian process mean from GPAC should be a better approximation to the mean reflectance of a set of endmembers than a constant universal mean, and our test indicate that this is robustly true. While MODTRAN data was used rather than image data, it is expected that incorporating GPAC in place of UMR in QUACC would provide substantial significant robust improvement in atmospheric compensation. Moreover, the Gaussian process framework could similarly be used to predict the offset from an estimate based on the QUACC minimum-value approximation.

### REFERENCES

The following reference are incorporated herein by reference in their entireties.
Alexander Berk, Patrick Conforti, Rosemary Kennett, Timothy Perkins, Frederick Hawes, and Jeannette van den Bosch, “MOD-TRAN6: a major upgrade of the MODTRAN radiative transfer code,” in Algorithms and Technologies for Multispectral, Hyperspectral, and Ultraspectral Imagery XX, Miguel Velez-Reyes and Fred A. Kruse, Eds. International Society for Optics and Photonics, 2014, vol. 9088, p. 90880H, SPIE.
Dor Bank, Noam Koenigstein, and Raja Giryes, “Autoencoders,” arXiv preprint arXiv:2003.05991, 2020.
Pascal Vincent, Hugo Larochelle, Yoshua Bengio, and Pierre-Antoine Manzagol, “Extracting and composing robust features with denoising autoencoders,” in Proceedings of the 25th international conference on Machine learning, 2008, pp. 1096-1103.
Pascal Vincent, Hugo Larochelle, Isabelle Lajoie, Yoshua Bengio, Pierre-Antoine Manzagol, and Leon Bottou, “Stacked denoising autoencoders: Learning useful representations in a deep network with a local denoising criterion,” Journal of machine learning research, vol. 11, no. 12, 2010.
Cai Ruikai, “Research progress in image denoising algorithms based on deep learning,” in Journal of Physics: Conference Series. TOP Publishing, 2019, vol. 1345, p. 042055.
Lawrence S. Bernstein, Xuemin Jin, Brian Gregor, and Steven M. Adler-Golden, “Quick atmospheric correction code: algorithm description and recent upgrades,” Optical Engineering, vol. 51, no. 11, pp. 1-12, 2012.
Morris L Eaton, “Multivariate statistics: a vector space approach,” JOHN WILEY & SONS, INC., 605 THIRD AVE, NEW YORK, NY 10158, USA, 1983, 512, 1983.
Kaiming He, Xiangyu Zhang, Shaoqing Ren, and Jian Sun, “Deep residual learning for image recognition,” in Proceedings of the IEEE conference on computer vision and pattern recognition, 2016, pp. 770-778.
Hao Li, Zheng Xu, Gavin Taylor, Christoph Studer, and Tom Goldstein, “Visualizing the loss landscape of neural nets,” Advances in neural information processing systems, vol. 31, 2018.
Timothy Perkins, Steven M. Adler-Golden, Michael W. Matthew, Alexander Berk, Lawrence S. Bernstein, Jamine Lee, and Marsha Fox, “Speed and accuracy improvements in FLAASH atmospheric correction of hyperspectral imagery,” Optical Engineering, vol. 51, no. 11, pp. 1-8, 2012.
Baabak G Mamaghani, Geoffrey V Sasaki, Ryan J Connal, Kevin Kha, Jackson S Knappen, Ryan A Hartzell, Evan D Marcellus, Timothy D Bauch, Nina G Raquerio, and Carl Salvaggio, “An initial exploration of vicarious and in-scene calibration techniques for small unmanned aircraft systems,” in Autonomous Air and Ground Sensing Systems for Agricultural Optimization and Phenotyping III. International Society for Optics and Photonics, 2018, vol. 10664, p. 1066406.
Bo-Cai Gao, Marcos J Montes, Curtiss 0 Davis, and Alexander FH Goetz, “Atmospheric correction algorithms for hyperspectral remote sensing data of land and ocean,” Remote sensing of environment, vol. 113, pp. S17-S24, 2009.
Leonid V. Katkovsky, Anton O. Martenov, Volha A. Siliuk, and Dimitry A. Ivanov, “SHARC method for fast atmospheric correction of hyperspectral data,” in Remote Sensing of Clouds and the Atmosphere XXIII, Adolfo Comerón, Evgueni I. Kassianov, Klaus Schafer, Richard H. Picard, and Konradin Weber, Eds. International Society for Optics and Photonics, 2018, vol. 10786, pp. 53-65, SPIE.
Lawrence S Bernstein, Steven M Adler-Golden, Robert L Sundberg, Robert Y Levine, Timothy C Perkins, Alexander Berk, Anthony J Ratkowski, Gerald Felde, and Michael L Hoke, “Validation of the quick atmospheric correction (quac) algorithm for vnir-swir multi- and hyperspectral imagery,” in Algorithms and Technologies for Multispectral, Hyperspectral, and Ultraspectral Imagery XI. SPIE, 2005, vol. 5806, pp. 668-678.

It will be understood that modifications to the embodiments disclosed herein can be made to meet a particular set of design criteria. For instance, any of the components discussed herein can be any suitable number or type of each to meet a particular objective. Therefore, while certain exemplary embodiments of the system and methods of making and using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein. Additionally, the disclosure of a range of values is a disclosure of every numerical value within that range, including the end points.

What is claimed is:

1. A system for producing a digital image by automatically correcting for scattering and/or absorption effects in an original digital image, the system comprising:
a processor;
memory containing a computer program that when executed will cause the processor to:
receive radiance spectra of a digital image; and
execute a Gaussian machine learning model to:
generate a reflectance parameter by predicting a ground reflectance value based on a Gaussian probability distribution of radiance spectra;
solve for a conversion coefficient based on the reflectance parameter; and
produce an altered digital image by at least one or more of removing, filtering, and/or altering data for at least one pixel of a digital image based on the conversion coefficient.

2. The system of claim 1, wherein:
the computer program will cause the processor to receive a digital image and extract radiance spectra therefrom.

3. The system of claim 1, wherein:
the computer program will cause the processor to receive a digital image from an imaging device.

4. The system of claim 3, in combination with the imaging device.

5. The system of claim 1, wherein:
the computer program will cause the processor to generate plural reflectance parameters and solve for plural conversion coefficients based on the plural reflectance parameters.

6. The system of claim 1, wherein:
the computer program will cause the processor to predict a ground reflectance value by generating one or more approximate ground reflectance output vectors from one or more radiance spectra input vectors in a Bayesian framework.

7. The system of claim 1, wherein:
the computer program will cause the processor to generate the altered digital image by at least one or more of removing, filtering, and/or altering data pertaining to a scattering and/or absorption effect on reflectance of a digital image.

8. The system of claim 1, wherein:
the computer program will cause the processor to generate the altered digital image by generating at least one or more offset values and applying the at least one or more offset values to at least one pixel of a digital image.

9. The system of claim 1, wherein:
the computer program will cause the processor to generate the altered digital image by generating an offset value and applying the offset value to each pixel of a digital image.

10. The system of claim 1, wherein:
the computer program will cause the processor to execute a denoising autoencoder machine learning model to:
encode digital image data by passing digital image data through plural layers of a deep learning neural network that decrease in size leading to a dimensionally smaller representation of the data;
decode digital image data by passing encoded digital image data through a symmetric series of layers until the reaching a data shape before being encoded; and
learn a representation of data in a reduced dimensional space to facilitate removal of noise during encoding and recovery of data in original space during decoding.

11. A computer implemented method for producing a digital image by automatically correcting for scattering and/or absorption effects in an original digital image, the method comprising:
receiving radiance spectra of a digital image;
generating a reflectance parameter by predicting a ground reflectance value based on a Gaussian probability distribution of radiance spectra;
solving for a conversion coefficient based on the reflectance parameter; and
producing an altered digital image by at least one or more of removing, filtering, and/or altering data for at least one pixel of a digital image based on the conversion coefficient.

12. The method of claim 11, comprising:
receiving a digital image and extracting radiance spectra therefrom.

13. The method of claim 11, comprising:
receiving a digital image from an imaging device.

14. The method of claim 11, comprising:
generating plural reflectance parameters and solving for plural conversion coefficients based on the plural reflectance parameters.

15. The method of claim 11, wherein:
predicting a ground reflectance value includes generating one or more approximate ground reflectance output vectors from one or more radiance spectra input vectors in a Bayesian framework.

16. The method of claim 11, wherein:
generating the altered digital image includes at least one or more of removing, filtering, and/or altering data pertaining to a scattering and/or absorption effect on reflectance of a digital image.

17. The method of claim 11, wherein:
generating the altered digital image includes generating at least one or more offset values and applying the at least one or more offset values to at least one pixel of a digital image.

18. The method of claim 11, wherein:
generating the altered digital image includes generating an offset value and applying the offset value to each pixel of a digital image.

19. The method of claim 11, comprising:
encoding digital image data by passing digital image data through plural layers of a deep learning neural network that decrease in size leading to a dimensionally smaller representation of the data;
decoding digital image data by passing encoded digital image data through a symmetric series of layers until the reaching a data shape before being encoded; and
learning a representation of data in a reduced dimensional space to facilitate removal of noise during encoding and recovery of data in original space during decoding.
